(19) United States
(12) Patent Application Publication
(10) Pub. No.: US 2011/0108669 A1
(43) Pub. Date: May 12, 2011

(54) VARIABLE SPEED DROGUE

(75) Inventor: William L. Kirkland, Kingman, AZ (US)

(73) Assignee: WEST COAST NETTING, INC., Kingman, AZ (US)

(21) Appl. No.: 12/841,949

(22) Filed: Jul. 22, 2010

Related U.S. Application Data
(60) Provisional application No. 61/228,099, filed on Jul. 23, 2009.

(51) Int. Cl. B64D 39/00

(52) U.S. Cl. 244/135 A

(57) ABSTRACT

The variable speed drogue includes a plurality of leading edge struts and trailing edge struts pivotally mounted to a refueling coupling member, and a drogue canopy connected between the trailing ends of the leading edge and trailing edge struts. A spring and an articulated strut brace assembly are connected between each of the leading edge and trailing edge struts. A center strut is pivotally connected to the trailing end of each leading edge strut, and each center strut includes a free end connected to a center portion of the canopy drogue. The drogue canopy is connected to the trailing ends of the leading edge and trailing edge struts such that the drogue canopy is movable between a radially inward position and a radially outward position, to provide substantially constant loads on the drogue within the range of refueling speeds.

### CROSS-REFERENCE TO RELATED APPLICATIONS

This application is based on Provisional Application No. 61/228,099, filed Jul. 23, 2009.

### BACKGROUND OF THE INVENTION

This invention relates generally to aerodynamic drogues for aerial inflight refueling, and more particularly concerns an improved aerial inflight refueling drogue assembly having a spring loaded bleeding drogue that allows the bleeding drogue to extend as the speed increases and the load on the drogue increases, to maintain substantially constant loads on the drogue within a range of refueling speeds.

The high amount of drag provided by a drogue for refueling can cause the trail angle of the refueling hose and coupling to become flattened. It is desirable that the refueling aircraft not follow directly in the wake of the tanker aircraft, so that the configuration of a drogue which may be appropriate for low air speed refueling can be inappropriate for high speed refueling, even if the motion of the refueling coupling can be stabilized by aerodynamic designs.

It has therefore been a common practice to install either a low or high speed configuration drogue on the refueling coupling of a tanker aircraft on the ground, depending upon whether the aerial refueling is to take place at low or high speed, and to land to change the drogue to another speed configuration when an aircraft needs to be refueled at a different speed. Another approach has been to fabricate the ring shaped parachute canopy of the drogue of elastic material with openings which permit pressure modulation to provide for a constant amount of drag over varying speeds. However, such elastic openings have been found to be subject to deterioration, which can cause the amount of drag provided by the drogue to decrease over time, and can also cause an asymmetrical drag configuration to develop.

There is therefore a continuing need for a variable speed drogue which can maintain a substantially constant load on the drogue over a range of refueling speeds, and which is not generally susceptible to deterioration or damage from a refueling probe. It would also be desirable to provide a refueling drogue system that requires no modifications to a refueling tanker aircraft, and can be bolted on to a conventional coupling for conventional drogue frames and drogues, and that will permit refueling to be done from the lowest through the highest aircraft refueling speeds. The present invention meets these and other needs.

### SUMMARY OF THE INVENTION

Briefly, and in general terms, the present invention provides for an aerial refueling drogue that provides stability and remains inflated throughout a range of refueling speeds. The aerial refueling drogue is a bleeding type of drogue that provides substantially constant loads over a range of refueling speeds managed through movement of the refueling drogue between a retracted position and an extended position. The aerial refueling drogue system does not require modification to a refueling tanker aircraft, and can be mounted to a conventional coupling for conventional drogue frames and drogues.

The invention accordingly provides for a variable speed drogue for use with an inflight aerial refueling system. A refueling system commonly includes a fuel supply, a fuel line having a leading or forward end in fluid communication with the fuel supply, and a refueling coupling member connected to the fuel line for receiving a refueling probe. In one presently preferred embodiment, the variable speed drogue includes a plurality of first or leading edge struts, and a plurality of second or trailing edge struts, mounted to a trailing edge portion of a reception coupling, and a drogue canopy having a leading edge and a trailing edge. A plurality of springs and an articulated strut brace assembly are operatively connected between the first and second struts, such that the drogue canopy connected to the trailing ends of the first and second struts is movable between a radially inwardly folded or collapsed position and a radially outwardly extended position, whereby over a range of refueling speeds the drogue retracts radially inwardly as the speed increases and the load on the drogue increases, and extends radially outwardly as the speed decreases and the load on the drogue decreases, to maintain substantially constant loads on the bleeding drogue within the range of refueling speeds.

In another aspect, a center strut is pivotally connected to the aft or trailing end of each leading edge strut, and each center strut includes a free end with a hook or other means for connecting to a middle or center portion of the canopy drogue. Each center strut is connected by a stowage cord to a corresponding radially outer strut brace, so that when the drogue assembly is folded inwardly for stowage, the radially outer strut brace arm will pull and fold the corresponding center strut against the leading edge strut for proper stowage.

These and other aspects and advantages of the invention will become apparent from the following detailed description and the accompanying drawings, which illustrate by way of

### BRIEF DESCRIPTION OF THE DRAWINGS

FIG. 1 is a schematic sectional elevational view of the variable speed drogue of the present invention shown in a relatively radially outward flying position, with the upper portion of the drogue canopy shown in a low speed position with a drogue modulation cord in a fully retracted position, and the lower portion shown in a high speed position with the drogue modulation cord in an extended position.

FIG. 2 is a schematic sectional elevational view of the variable speed drogue of the present invention shown in a relatively radially inwardly folded position for stowage.

### DETAILED DESCRIPTION OF THE PREFERRED EMBODIMENTS

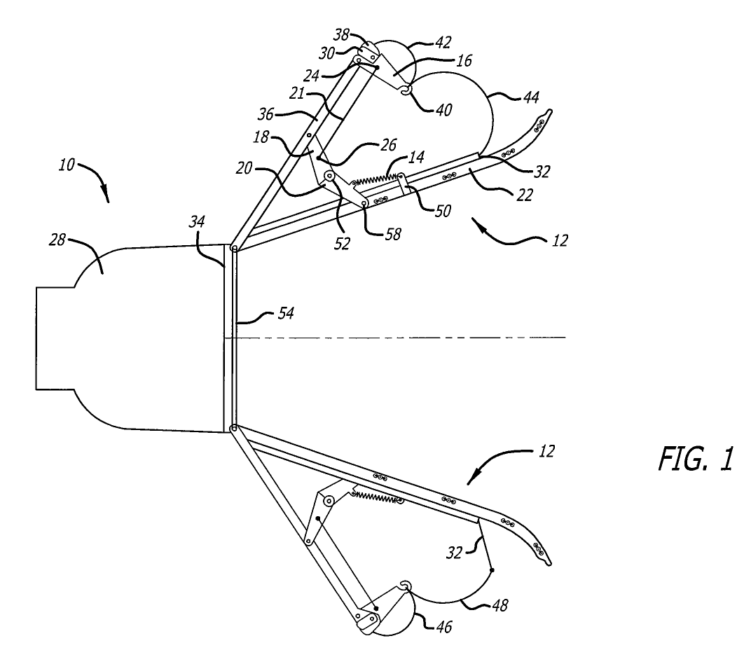

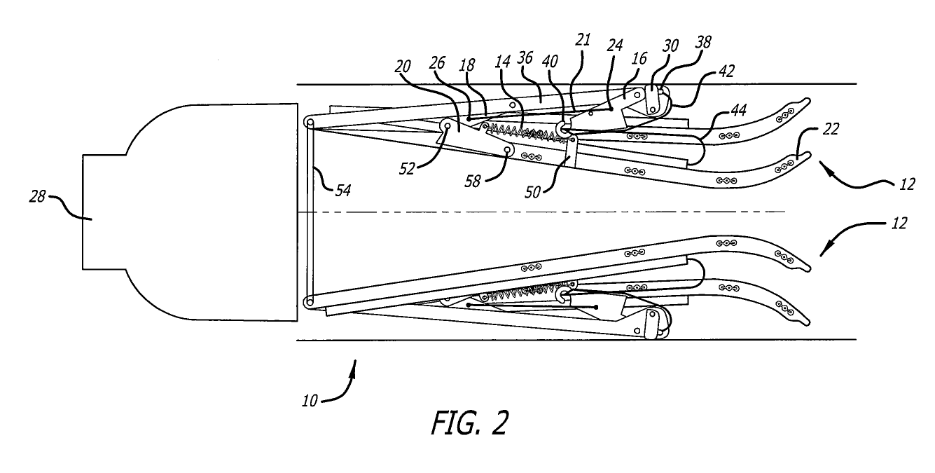

Referring to FIGS. 1 and 2, which are provided by way of example, and not by way of limitation, the present invention provides for a variable speed drogue that is configured to be used with an inflight aerial refueling system. Such an inflight aerial refueling system typically includes a fuel supply (not shown), such as a fuel tank in a tanker aircraft, an aircraft drogue stowage tube (not shown) which can be mounted in a wing pod or fuselage of a tanker aircraft for stowing the drogue, and a fuel supply hose (not shown) that can be extended and retracted during flight for refueling other aircraft, that is connected for fluid communication with the fuel supply. As is illustrated in FIGS. 1 and 2, the variable speed drogue 10 includes a paradrogue frame 12, a drogue canopy 42, 46 and 44, 48, and a reception coupling 28. The reception coupling 28 includes a forward portion configured to be connected to a fuel supply hose (not shown) that is trailed from a tanker aircraft during aerial refueling, and an open rearward throat section configured to connect with a refueling probe (not shown) of a receiver aircraft that is refueling.

A plurality of leading edge struts 36 are pivotally mounted to the trailing edge portion of the refueling coupling member, such as by connection to a connecting ring at the trailing edge strut open control stop (with resilient bumper) 34 and an attachment bar 54 of the refueling coupling member. The leading edge struts 36 each have a leading end and a trailing end, and typically there are 18 leading edge struts 36 arrayed around the trailing edge of the refueling coupling member.

A plurality of trailing edge struts 22, each having a leading end and a trailing end, are also preferably mounted in the same manner as the leading edge struts 36 to the trailing edge portion of the refueling coupling member at the attachment bar 54. There are also typically 18 trailing edge struts 22 arrayed around the trailing edge of the refueling coupling member, with a trailing edge modulating cord 32 disposed about the trailing edge struts 22. The trailing edge modulating cord 32 connects each of the plurality of trailing edge struts 22 to the drogue canopy.

A drogue canopy having a leading edge 42, 46, a trailing edge 44, 48, and a center canopy attachment 40, extends between the trailing edges of the leading edge struts 36 and the trailing edge struts 22. The drogue canopy 42, 44 is preferably attached to the center strut 16 such as by a cord, cable, hooks or loops, or the like.

Each of the trailing edge struts 22 includes a strut opening control spring 14 connected between the trailing edge strut 22 and the radially outward arm of a corresponding articulated strut brace 20 by a radially inward trailing edge strut extension lever 50, such that the drogue canopy connected to the trailing ends of the first 36 and second struts 22 is movable between a radially inwardly folded or collapsed position and a radially outwardly extended position, whereby over a range of refueling speeds the drogue retracts radially inwardly as the speed increases and the load on the drogue increases, and extends radially outwardly as the speed decreases and the load on the drogue decreases, to maintain substantially constant loads on the drogue within the range of refueling speeds.

A leading edge combo strut brace 18 and the trailing edge strut brace 20 are pivotally connected at an attachment point 52, with stowage cord attachment points 24, 26 on the leading edge combo strut brace 18 and the center strut 16. Each center strut 16 is connected by a stowage cord 21 to a corresponding radially outer strut brace, so that when the drogue assembly is folded inwardly for stowage, the radially outer strut brace arm will pull and fold the corresponding center strut 16 against the leading edge strut 36 for proper stowage. The leading edge combo strut brace 18 is pivotally connected to the leading edge combo strut 36 at an attachment point 56. Similarly, the trailing edge strut brace 20 is pivotally connected to the trailing edge strut 22 at an attachment point 58.

A leading edge canopy attachment 38 is disposed about a center strut positioning block 30 that also retains a leading edge canopy cord 42, 46. In another presently preferred aspect, the drogue canopy is connected to each of the pluralities of trailing edge struts by a trailing edge modulating cord.

It should be evident from the foregoing that the variable speed drogue of the invention provides substantially constant loads over a range of refueling speeds by spring loading of the aft bleeding drogue for movement between a retracted position and an extended position. It is further significant that the variable speed refueling drogue is not generally susceptible to deterioration or damage from a refueling probe.

It will be apparent from the foregoing that while particular forms of the invention have been illustrated and described, various modifications can be made without departing from the spirit and scope of the invention.

### Listing of Elements

10. variable speed drogue
12. paradrogue frame
14. strut opening control spring
16. center strut
18. leading edge combo strut brace
20. trailing edge strut brace
21. stowage cord
22. trailing edge strut
24. center strut stowage cord attachment
26. leading edge strut brace stowage cord attachment
28. reception coupling
30. center strut positioning block/leading edge canopy cord retainer
32. trailing edge modulating cord
34. trailing edge strut open control stop with resilient bumper
36. leading edge combo strut
38. leading edge canopy attachment
40. leading edge and trailing edge center canopy attachment
42. leading edge canopy lobe/low speed
44. trailing edge canopy lobe/low speed
46. leading edge canopy lobe/foil design
48. trailing edge canopy lobe/high speed modulated
50. radially inward trailing edge strut extension lever (connecting strut opening control spring to trailing edge strut brace)
52. leading edge combo strut brace and trailing edge strut brace pivotal connection
54. leading edge strut and trailing edge strut attachment bar
56. leading edge combo strut and leading edge combo strut brace pivotal connection
58. trailing edge strut and trailing edge strut brace pivotal connection

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A variable speed drogue assembly for an inflight aerial refueling system, comprising:
a paradrogue frame, including a plurality of leading edge struts and a plurality of trailing edge struts;
a drogue canopy connected between said plurality of leading edge struts and said plurality of trailing edge struts;
a center strut pivotally connected to the trailing ends of each of said pluralities of leading edge struts, each center strut connected to a center portion of the drogue canopy; and
a reception coupling, said plurality of leading edge struts and said plurality of trailing edge struts being pivotally connected to a trailing end of said reception coupling.

2. The variable speed drogue assembly of claim 1 further comprising:
a plurality of springs and an articulated strut brace assembly connected between the leading edge struts and the trailing edge struts, such that the drogue canopy is movable between a radially inward position and a radially outward position as the speed of the drogue canopy increases and decreases and the load on the drogue canopy increases and decreases, respectively, to maintain substantially constant loads on the drogue canopy within a range of refueling speeds.

3. The variable speed drogue assembly of claim 2 wherein said articulated strut brace assembly comprises a leading edge strut brace and a trailing edge strut brace pivotally connected together.

4. The variable speed drogue assembly of claim 3 further comprising a stowage cord connected between said center strut and said leading edge strut brace, so that when the drogue assembly is folded inwardly for stowage, the radially outer strut brace will pull and fold the corresponding center strut against the leading edge strut.

5. The variable speed drogue assembly of claim 1 wherein said reception coupling comprises an attachment bar connected to said trailing end of said reception coupling, and wherein each of said pluralities of leading edge struts and said trailing edge struts is pivotally mounted to said attachment bar.

6. The variable speed drogue assembly of claim 1 wherein the reception coupling comprises a forward portion configured to be connected to a fuel supply hose that extends from a tanker aircraft during aerial refueling.

7. The variable speed drogue assembly of claim 6 wherein the reception coupling further comprises an open rearward throat section configured to connect with a refueling probe of a refueling receiver aircraft.

8. The variable speed drogue assembly of claim 1 wherein the leading edge struts each have a leading end and a trailing end and the trailing edge struts each have a leading end and a trailing end.

9. The variable speed drogue assembly of claim 1 wherein said drogue canopy is connected to each of said pluralities of trailing edge struts by a trailing edge modulating cord.

10. The variable speed drogue assembly of claim 3 wherein each of the trailing edge struts comprises a radially inward trailing edge, and a strut opening control spring connected between the radially inward trailing edge of said trailing edge struts and the trailing edge strut brace.

11. A variable speed drogue for use with an inflight aerial refueling system, the inflight aerial refueling system including a fuel supply, a fuel line having a forward end in fluid communication with the fuel supply, and a refueling coupling member connected to the fuel line for receiving a refueling probe, the variable speed drogue comprising:
a refueling coupling member having a trailing edge portion;
a plurality of first struts each having a first end and a second end, said first ends of said plurality of first struts being mounted to the trailing edge portion of said refueling coupling member;
a plurality of second struts each having a first end and a second end, said first ends of said plurality of second struts being mounted to the trailing edge portion of said refueling coupling member;
a drogue canopy having a leading edge and a trailing edge, said leading edge of said drogue canopy being connected to said second ends of said plurality of first struts, and said trailing edge of said drogue canopy being connected to said second ends of said plurality of second struts; and
an articulated spring loaded strut brace assembly connected between the first and second struts, such that the drogue canopy connected to the second ends of the first and second struts is movable between a radially inwardly folded position and a radially outwardly extended position, whereby over a range of refueling speeds the drogue canopy retracts radially inwardly as the speed increases and the load on the drogue canopy increases, and extends radially outwardly as the speed decreases and the load on the drogue canopy decreases, to maintain substantially constant loads on the drogue canopy within the range of refueling speeds.

12. The variable speed drogue of claim 11, further comprising a center strut pivotally connected to the second end of each leading edge strut, said center strut including a free end configured to be connected to a middle portion of the drogue canopy.

13. The variable speed drogue assembly of claim 11 wherein said articulated strut brace assembly comprises a radially outer strut brace and a radially inner strut brace pivotally connected together.

14. The variable speed drogue of claim 13, further comprising a stowage cord connected between each said radially outer strut brace and a corresponding one of said center struts, so that when the variable speed drogue is folded inwardly for stowage, each said radially outer strut brace will pull and fold the corresponding center strut against the corresponding leading edge strut for proper stowage.
